(19) United States
(12) Patent Application Publication
(10) Pub. No.: US 2013/0265423 A1
(43) Pub. Date: Oct. 10, 2013

(54) VIDEO-BASED DETECTOR AND NOTIFIER FOR SHORT-TERM PARKING VIOLATION ENFORCEMENT

(71) Applicants: Edgar A. Bernal, Webster, NY (US); Zhigang Fan, Webster, NY (US); Yao Rong Wang, Webster, NY (US); Robert P. Loce, Webster, NY (US); Norman W. Zeck, Ontario, NY (US); Graham S. Pennington, Webster, NY (US)

(72) Inventors: Edgar A. Bernal, Webster, NY (US); Zhigang Fan, Webster, NY (US); Yao Rong Wang, Webster, NY (US); Robert P. Loce, Webster, NY (US); Norman W. Zeck, Ontario, NY (US); Graham S. Pennington, Webster, NY (US)

(73) Assignee: XEROX CORPORATION, Norwalk, CT (US)

(21) Appl. No.: 13/441,294

(22) Filed: Apr. 6, 2012

(51) Int. Cl. H04N 7/18; G08B 21/18

(52) U.S. Cl. 348/148; 348/E07.085

(57) ABSTRACT

A method for determining the occurrence of a short-term parking violation includes receiving video data in a sequence of frames provided by an image capture device monitoring a parking area over a duration of time. The method includes determining the presence of a vehicle captured in at least one of the sequence of frames. The method tracks the location of the vehicle across the sequence of frames. The method further determines a spatial location of the vehicle in each frame. The method includes determining spatio-temporal information describing the location of the vehicle as a function of time by associating the spatial location of the vehicle at each frame with the time instant at which the frame was captured. In response to the spatio-temporal information indicating that the vehicle becomes stationary, the method determines a duration that the vehicle is stationary using the determined spatio-temporal information of the vehicle.

### CROSS REFERENCE TO RELATED PATENTS AND APPLICATIONS

This application is related to co-pending Application Number [Atty. Dkt. No. 20120095-US-PSP], filed herewith, entitled “A System and Method for Available Parking Space Estimation for Multispace On-Street Parking”, by Orhan Bulan et al.; and co-pending Application Number [Atty. Dkt. No. 20120243-US-PSP], filed herewith, entitled “A Video-Based System and Method for Detecting Exclusion Zone Infractions”, by Orhan Bulan et al., each of which is incorporated herein in their entireties.

### BACKGROUND

The present disclosure relates to a system and method for tracking a vehicle to determine an occurrence of a parking violation. However, it is appreciated that the present exemplary embodiments are also amendable to other like applications.

Traditionally, a detection of short-term parking violations has been indicated by a time-expired reading on a parking meter or through an observation made by an enforcement officer. In the latter instance, an officer applies chalk to tires of the vehicles violating the parking regulation on a first visit and returns to issue tickets to the previously marked vehicles on a second visit. Both of these processes are being phased out for a number of reasons. Namely, the processes are costly in labor required to inspect meters and in missed fines from undetected meters. The single stall meters are furthermore undesirable because they require space to accommodate one meter per every one or two parking spots. They are also susceptible to vandalism and theft.

Recently, sensor-based solutions have been proposed for monitoring parking spaces. For example, “puck-style” sensors and ultrasonic ceiling or in-ground sensors output a binary signal when a vehicle is detected in a parking space. The detected information is wirelessly communicated to a user device. One disadvantage associated with these sensor-based methods is a high cost for installation and maintenance of the sensors. In addition, the maintenance or replacement of a sensor may reduce parking efficiency if a parking space is made unavailable for the service work.

Another technique that is being explored for enforcing parking regulations is a video-based solution. This method includes monitoring on-street parking spaces using non-stereoscopic video cameras. The video-based system outputs a binary signal to a processor, which uses the data for determining occupancies of the parking spaces. The known techniques are adapted to capture a parking area. However, there is no video-based solution that is adapted to track vehicle activity and inactivity in the parking area. Furthermore, variation in illumination and obscuration can result in vehicle detection errors. A system and a method are therefore needed that avoids these sources of inaccuracy by tracking the vehicle relative to the parking space.

The present disclosure provides an automated video-based system for detection and notification of short-term parking violations. The proposed system is cost effective and is able to monitor both single stalls and multiple parking spaces.

### BRIEF DESCRIPTION

A first embodiment of the disclosure relates to a method for determining the occurrence of a short-term parking violation. The method includes receiving video data in a sequence of frames provided by an image capture device monitoring a parking area over a duration of time. The method includes determining the presence of a vehicle captured in at least one of the sequence of frames. The method tracks the location of the vehicle across the sequence of frames. The tracking includes determining spatio-temporal information describing the location of the vehicle as a function of time by associating the spatial location of the vehicle at each frame with the time instant at which the frame was captured. In response to the spatio-temporal information indicating that the vehicle becomes stationary, the method determines a duration that the vehicle is stationary using the determined spatio-temporal information of the vehicle.

Another embodiment of the disclosure relates to a system for determining the occurrence of a short-term parking violation. The system includes a monitoring device having a processor that is adapted to implement modules. A video buffering module is adapted to receive video data in a sequence of frames provided by an image capture device in communication with the video capture device and monitor a parking area over a duration of time. A vehicle detection module is adapted to determine a presence of a vehicle captured in at least one of the sequence of frames. A vehicle tracking module is adapted to track a spatio-temporal location of the vehicle across the sequence of frames. A stationary vehicle monitoring module is adapted to determine whether the vehicle has become stationary using the spatio-temporal data. A timing module is adapted to determine a duration that the vehicle is stationary using spatio-temporal information.

### BRIEF DESCRIPTION OF THE DRAWINGS

FIG. 1 shows an example scenario of the present disclosure being applied to determine a vehicle approaching a parking space regulated by a time limit.

FIG. 2 shows the disclosure detecting a parking violation by the vehicle in FIG. 1.

FIG. 3 is a schematic illustration of a vehicle tracking and violation detection system according to one embodiment.

FIG. 4 is a flowchart describing an overview of a method for tracking a vehicle for determining a parking violation.

FIG. 5 is a flowchart describing a detailed method for tracking a vehicle for determining a parking violation.

FIGS. 6-9 show results of an example implementation of the present disclosure.

### DETAILED DESCRIPTION

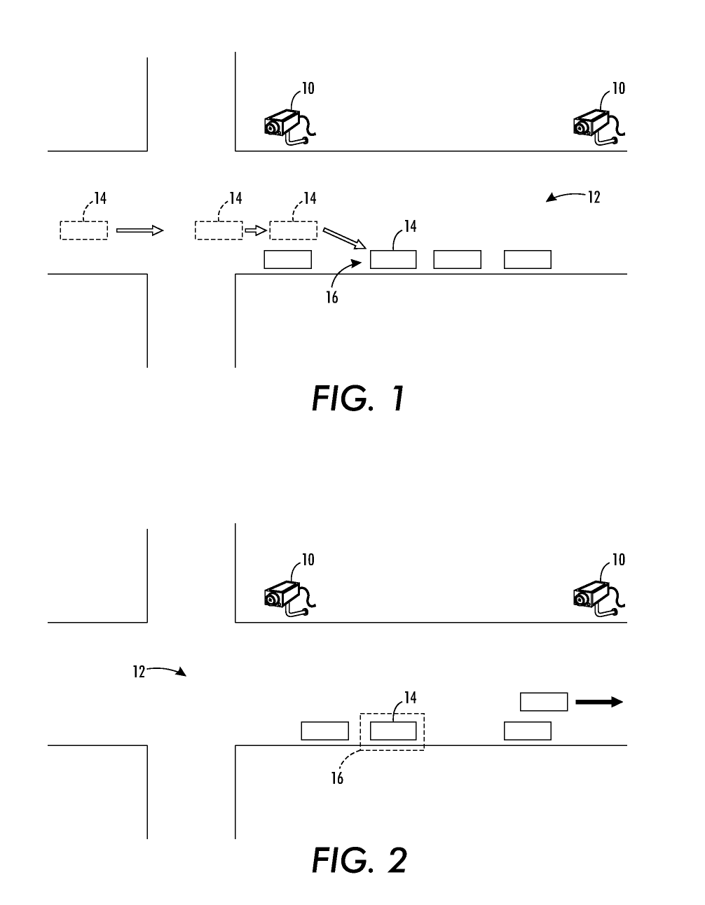

The present disclosure relates to an automated video-based system and method for tracking a vehicle for detecting short-term parking violations. FIG. 1 shows an example scenario of the present disclosure being applied to determine a vehicle approaching a parking space that is regulated by a time limit. At least one video camera 10 monitors a parking area 12. Using the acquired video data, the system detects a moving vehicle 14 (shown in phantom) in the field of view. The system tracks the detected vehicle 14 as it approaches a parking space 16 in the parking area. FIG. 2 shows the system detecting a parking violation made by the vehicle shown in the example scenario of FIG. 1. After the vehicle enters the parking space 16, the system monitors the vehicle 14 to determine a duration that the vehicle remains parked in the space 16 (shown in phantom). The system triggers a notification in response to the vehicle 14 remaining parked in the sequence for a period of time meeting or exceeding a predetermined threshold.

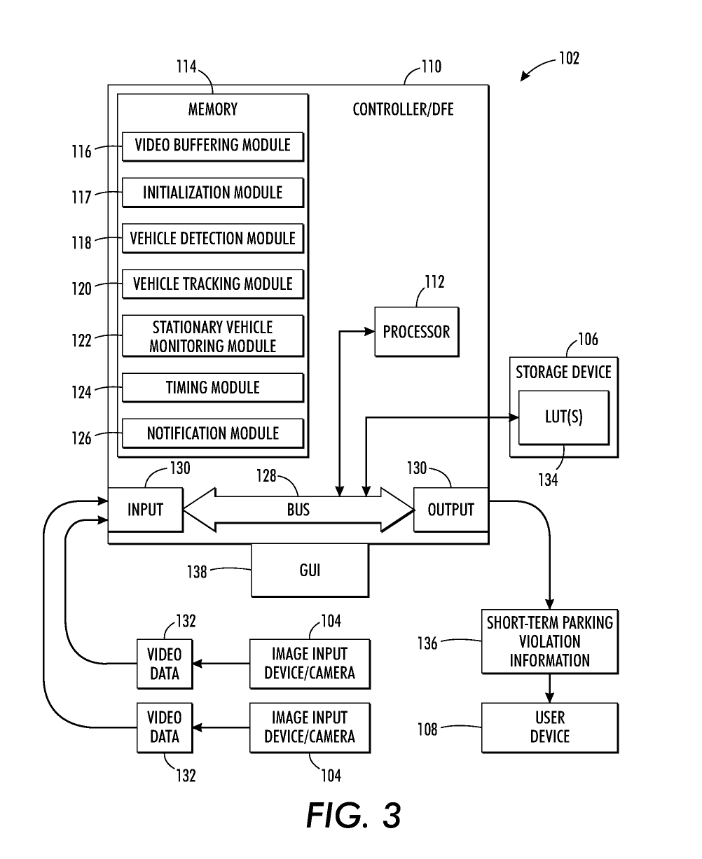

FIG. 3 is a schematic illustration of a vehicle tracking and violation detection system 100 in one exemplary embodiment. The system includes a tracking device 102, an image capture device 104, and a storage device 106, which may be linked together by communication links, referred to herein as a network. In one embodiment, the system 100 may be in further communication with a user device 108. These components are described in greater detail below.

The tracking device 102 illustrated in FIG. 3 includes a controller 110 that is part of or associated with the tracking device 102. The exemplary controller 110 is adapted for controlling an analysis of video data received by the system 100. The controller 110 includes a processor 112, which controls the overall operation of the tracking device 102 by execution of processing instructions that are stored in memory 114 connected to the processor 112.

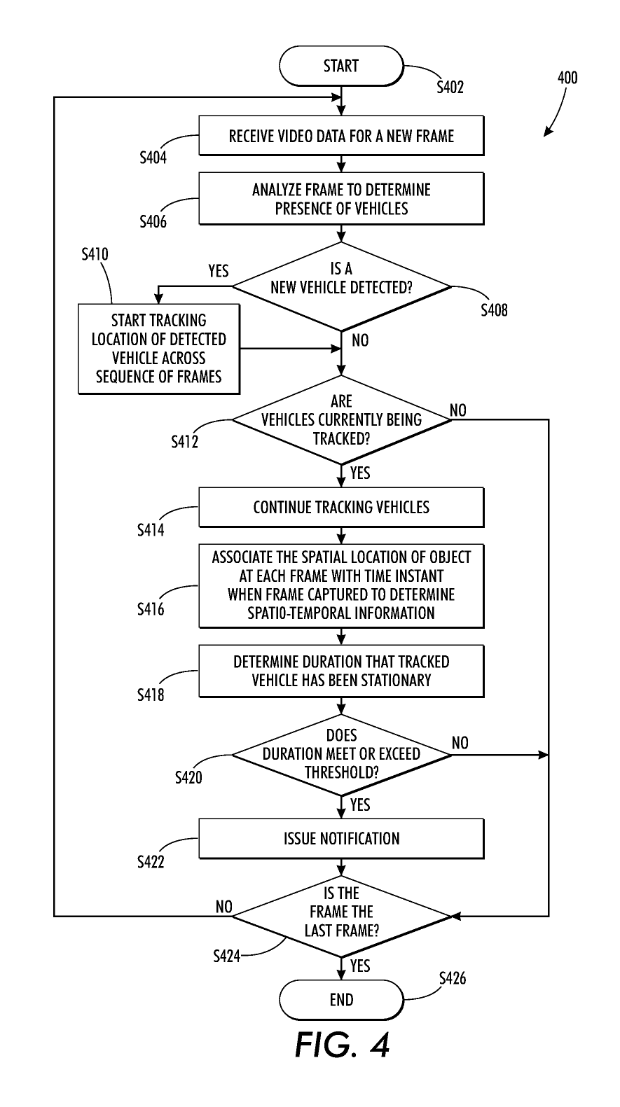

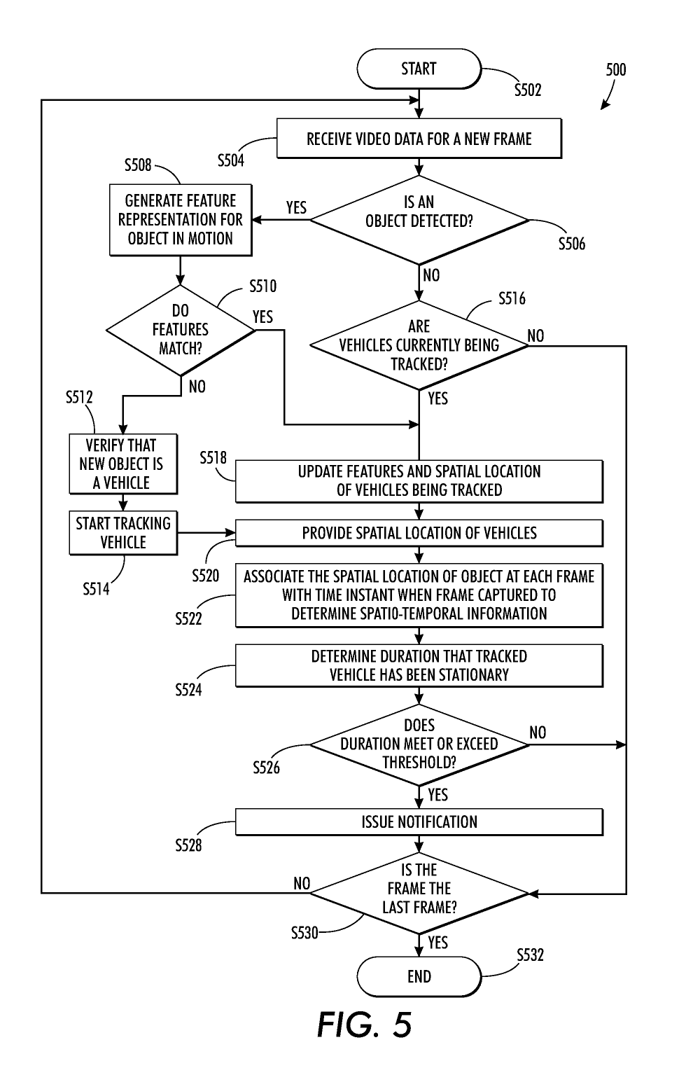

The memory 114 may represent any type of tangible computer readable medium such as random access memory (RAM), read only memory (ROM), magnetic disk or tape, optical disk, flash memory, or holographic memory. In one embodiment, the memory 114 comprises a combination of random access memory and read only memory. The digital processor 112 can be variously embodied, such as by a single-core processor, a dual-core processor (or more generally by a multiple-core processor), a digital processor and cooperating math coprocessor, a digital controller, or the like. The digital processor, in addition to controlling the operation of the tracking device 102, executes instructions stored in memory 114 for performing the parts of the method outlined in FIGS. 4 and 5. In some embodiments, the processor 112 and memory 114 may be combined in a single chip.

The tracking device 102 may be embodied in a networked device, such as the image capture device 104, although it is also contemplated that the tracking device 102 may be located elsewhere on a network to which the system 100 is connected, such as on a central server, a networked computer, or the like, or distributed throughout the network or otherwise accessible thereto. The vehicle tracking and violation detection phases disclosed herein are performed by the processor 112 according to the instructions contained in the memory 114. In particular, the memory 114 stores a video buffering module 116, which captures video of a select parking area; an initialization module 117, which determines positions of vehicles parked in the first frame of the sequence; a vehicle detection module 118, which detects objects and/or vehicles that are in motion within a field of view of the camera; a vehicle tracking module 120, which tracks the vehicles that were detected by the motion detection module; a stationary vehicle monitoring module 122, which monitors a location of vehicles that are parked in the spaces of interest; a timing module 124, which chronometers a duration that a vehicle remains parked in a given space; and, a notification module 126, which triggers a notification to enforcement authorities when a violation is determined. Embodiments are contemplated wherein these instructions can be stored in a single module or as multiple modules embodied in the different devices. The modules 116-126 will be later described with reference to the exemplary method.

The software modules as used herein, are intended to encompass any collection or set of instructions executable by the tracking device 102 or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server (not shown) or other location to perform certain functions. The various components of the tracking device 102 may be all connected by a bus 128.

With continued reference to FIG. 3, the tracking device 102 also includes one or more communication interfaces 130, such as network interfaces, for communicating with external devices. The communication interfaces 130 may include, for example, a modem, a router, a cable, and/or Ethernet port, etc. The communication interfaces 130 are adapted to receive video and/or image data 132 as input.

The tracking device 102 may include one or more special purpose or general purpose computing devices, such as a server computer or digital front end (DFE), or any other computing device capable of executing instructions for performing the exemplary method.

FIG. 3 further illustrates the tracking device 102 connected to an image source 104 for inputting and/or receiving the video data and/or image data (hereinafter collectively referred to as “video data”) in electronic format. The image source 104 may include an image capture device, such as a camera. The image source 104 can include one or more surveillance cameras that capture video data from the parking area of interest. The number of cameras may vary depending on a length and location of the area being monitored. It is contemplated that the combined field of view of multiple cameras typically comprehends all exclusion zones. For performing the method at night in parking areas without external sources of illumination, the cameras 104 can include near infrared (NIR) capabilities at the low-end portion of a near-infrared spectrum (700 nm-1000 nm).

In one embodiment, the image source 104 can be a device adapted to relay and/or transmit the video captured by the camera to the tracking device 102. In another embodiment, the video data 132 may be input from any suitable source, such as a workstation, a database, a memory storage device, such as a disk, or the like. The image source 104 is in communication with the controller 110 containing the processor 112 and memories 114.

With continued reference to FIG. 3, the system 100 includes a storage device 106 that is part of or in communication with the tracking device 102. In a contemplated embodiment, the tracking device 102 can be in communication with a server (not shown) that includes a processing device and memory, such as storage device 106, or has access to a storage device 106, for storing look-up tables (LUTs) that associates maximum allowable parking times for particular parking spaces. The storage device 106 includes a repository, which stores at least one (previously generated) look-up-table (LUT) 134 for each particular camera used by the system 100.

With continued reference to FIG. 3, the video data 132 undergoes processing by the tracking device 102 to output notice of a short-term parking violation 136 to an operator in a suitable form on a graphic user interface (GUI) 138 or to a user device 108, such as a computer belonging to an enforcement authority. The user device 108 can include a computer at a dispatch center, a smart phone belonging to an enforcement driver in transit or to a vehicle computer and/or GPS system that is in communication with the tracking device 102. In another contemplated embodiment, the user-device 108 can belong to a driver of the vehicle that is violating the short-term parking. In this manner, the driver can be put on notice that the vehicle should be moved. The GUI 138 can include a display, for displaying information, such as the location of the infraction and information regarding the vehicle violating the short-term parking, to users, and a user input device, such as a keyboard or touch or writable screen, for receiving instructions as input, and/or a cursor control device, such as a mouse, trackball, or the like, for communicating user input information and command selections to the processor 112.

FIG. 4 is a flowchart describing an overview of a method 400 for tracking a vehicle for determining a parking violation. The method starts at S402. The system receives video data in a sequence of frames provided by the image capture device at S404. The frames are analyzed to determine the presence of vehicles at S406. A vehicle detection module 118 determines whether a new vehicle is detected in a current frame at S408. In other words, the module 118 determines if a vehicle has entered the scene. In response to new vehicle detection (YES at S408), the vehicle tracking module 120 starts tracking the vehicle at S410. In response to no vehicle detection (NO at S408), the module 120 determines whether other vehicles are currently being tracked at S412. The location of the detected vehicles and of vehicles currently being tracked is tracked across the sequence of frames at S414. Using the tracked location, a spatial location of the vehicle is determined for each frame. Spatio-temporal information is determined for describing the location of the detected vehicle as a function of time at S416. The spatio-temporal information is determined by associating the spatial location of the vehicle at each frame with the time instant at which the frame was captured. Using the spatio-temporal information, the timing module 124 determines a duration that the vehicle is stationary at S418. A notification module 126 determines whether the duration meets or exceeds a threshold parking time limit at S420. In response to the duration meeting or exceeding the threshold (YES at S420), the module 126 triggers a short-term parking violation warning at S422. Otherwise (NO at S420), the system determines whether the current frame is the last frame in the sequence at S424. The process repeats starting at S404 in response to the current frame not being the last frame (NO at S424). In response to the current frame being the last frame (YES at S424), the method ends at S426.

FIG. 5 is a flowchart describing a detailed method 500 for tracking a vehicle for determining a parking violation. The method starts at S502. The video buffering module 116 receives video data from a sequence of frames taken from the image capture device 104 monitoring a parking area at S504. The video buffering module 116 transmits the video data to the vehicle detection module 118.

Generally, the vehicle detection module 118 detects objects in motion in each frame of the sequence at S506. The pixels belonging to the stationary background construct are removed to identify moving objects in the foreground of a static image. Pixels belonging to the foreground object can undergo further processing to determine if the object is a vehicle or a non-vehicle.

Several processes are contemplated for determining the presence of objects in motion in the foreground of a static background. One embodiment is contemplated for a video feed having no foreground objects in the static image captured in the first frame. In other words, a foreground image is absent in a first frame. The background is initialized as a reference (or known) background in the first frame. In this scenario, the module 118 compares the background in each frame/image of the video sequence with the reference background. The comparison includes determining an absolute color and/or intensity difference between pixels at corresponding locations in the reference background and the current background. The difference is compared to a threshold. Generally, a small difference is indicative that there is no change in the backgrounds. A large difference for a pixel (or group of pixels) between the first frame and a respective frame is indicative that a foreground object/vehicle has entered the scene in the respective frame. In response to the difference not meeting the threshold, the pixel is classified as belonging to a background image in the current frame. In response to the difference meeting the threshold, the pixel is classified as belonging to a foreground image in the current frame. This process is contemplated for environments having constant lighting conditions.

In another contemplated embodiment, a temporal difference process is contemplated for environments with variable lighting conditions, such as outdoor cameras, or in sequences having a foreground image in the first frame. Generally, subsequent (i.e., current) images are subtracted from an initial frame or a preceding frame. The difference image is compared to a threshold. Results of the threshold yield a region of change. More specifically, adjacent frames in a video sequence are compared. The absolute difference is determined between pixels at corresponding locations in adjacent frames. In other words, the process described above is repeated for each pair of adjacent frames.

In yet another embodiment, the background can be determined by averaging a number of frames over a specified period of time. There is no limitation made herein to a process that can be used for detecting a vehicle in motion. One process includes calculating a temporal histogram of pixel values within the set of video frames that are being considered for each pixel. The most frequent pixel value can be considered a background value. Clustering processes can be applied around this value to determine the boundaries between background and foreground values.

One aspect of comparing frames by the present vehicle detection module 118 is that it determines changes in the movement status of an object and/or vehicle across the sequence. The module 118 is used to detect continuously moving objects. Furthermore, morphological operations can be used along with the temporal difference process in the discussed embodiment. A morphological process that is understood in the art can be applied to the difference images to filter out sources of fictitious motion and to accurately detect vehicles in motion.

In summary, the vehicle detection module 118 detects the continuous movement of vehicles across frames by comparing frames. Differences between pixels at corresponding locations between frames that exceed predetermined thresholds are indicative of object movement. However, once the object stops, the difference between pixels at corresponding locations in subsequent frames becomes small. In this instance, the video detection module 118 determines that no moving object is detected in the current frame (NO at S506). In response to no moving object being detected, the vehicle tracking module 120 determines whether any vehicles detected in previous frames are still being tracked at S516.

With continued reference to FIG. 5, the vehicle tracking module 120 tracks the moving foreground object as it moves across different frames of the video feed. This module is also capable of continuing tracking even when the vehicle becomes stationary and is thus no longer part of the moving foreground. Several processes are contemplated for tracking the object. In one embodiment, the module 120 receives a determination (YES at S506) that a foreground object and/or vehicle (“original object”) is detected in a certain frame from the vehicle detection module 118. The frame can be analyzed to determine a location of the original foreground object and appearance (e.g. color, texture and shape) characteristics of the foreground object at S508. The extraction of the appearance characteristics of an object is performed via a feature representation of the object. A region proximate and containing the object location is identified in the frame. Using the location information, pixels at corresponding locations of the region are tracked across multiple, frames. The appearance characteristics and the location information of the object are compared to that of currently tracked and/or known objects that are identified in the corresponding regions of the other frames via a feature matching process, which establishes a correspondence between the different feature representations of the objects across frames at S510. The object in the current frame, including characteristics that match a reference object, are associated as being the vehicle (YES at S510). Accordingly, the features and spatial location information of the vehicle being tracked are updated for the current frame at S518. However, in response to the object in the current frame not having matching characteristics to a reference object (NO at S510), the vehicle tracking module determines that the object is a new object. A verification algorithm is performed to verify that the object is in-fact a new vehicle at S512. Tracking of the vehicle can begin at S514.

Other processes are also contemplated for tracking the vehicle. There is no limitation made herein to the type of process used. Processes known in the art, such as, Optical Flow, Mean-Shift Tracking, KLT tracking, Contour Tracking, and Kalman and Particle Filtering can be employed.

In another embodiment of the present disclosure, the vehicle tracking module 120 can apply a mean-shift tracking algorithm to track vehicles that move across the camera field of view. The algorithm is based on feature representations of objects that contain characteristics that can be represented in histogram form, such as color and texture. For example, when color is being used as a feature, the feature matching stage of the algorithm maximizes similarities in colors that are present in a number of frames to track the foreground object and/or vehicle across the frames. More specifically, module 120 generates a feature histogram of an object in a given frame at S508. The histogram relates to the appearance of a region in a first (i.e., reference) frame. The region can include an n×n pixel cell contained in the detected foreground object. In other words, the region can include a portion of the detected foreground object. This histogram becomes the reference histogram.

More specifically, the reference histogram graphically represents the number of pixels in the cell that are associated with certain color and/or intensity values. The histogram feature representation of the object/vehicle is determined to be the color distribution of pixels located in the region associated with the object/vehicle.

Multiple locations are identified in the neighborhood of the region described in which the reference histogram is computed. This is because it is expected for vehicles to have a smooth motion pattern, in other words, for locations of a given vehicle in adjacent frames to be in relatively close proximity. For subsequent frames, such as the current frame, histograms are computed for corresponding ones of the multiple possible locations where the vehicle could be located. These histograms are compared to the reference histogram at S510. The pixel region in the current frame having the histogram that best matches the reference histogram (YES at S510) is determined to be a new location of the vehicle. This determined region is associated as an updated location where the foreground object and/or vehicle has moved to in the subsequent frame at S518. Again, in response to the object in the current frame not having a pixel region that matches the reference histogram and possible locations of a vehicle being tracked (NO at S510), the vehicle tracking module determines whether the object is a new object. A verification algorithm is performed to verify that the object is in-fact a new vehicle at S512. The vehicle tracking module 120 uses this information to start tracking the vehicle at S514.

In summary, the vehicle tracking module 120 tracks the motion of the foreground object and/or vehicle across subsequent frames by searching for the best matching feature histogram or target histogram among a group of candidates within a neighborhood of the initial location of the reference histogram. One aspect of tracking using this process is that the mean-shift tracking algorithm based on color features is generally robust to partial occlusions, motion blur and changes in relative position between the object and the camera.

With continued reference to FIG. 5, the vehicle tracking module 120 provides the stationary vehicle monitoring module 122 with a spatial location (in pixel coordinates) of each foreground object and/or vehicle being monitored at every processed frame at S530. The vehicle monitoring module 122 uses this information to monitor vehicles that, while initially in motion, have become stationary at any given point in time. The module 122 is introduced to track slow-moving and/or stationary vehicles that are not detected by the vehicle detection module 118.

In response to a foreground object and/or vehicle becoming stationary after a period of initial movement, the system determines that the foreground object is a parked vehicle. Generally, the vehicle monitoring module 122 is adapted to monitor stationary objects for periods of time relative to a sampling rate. Location of stationary objects can also be monitored using tracking algorithms. In other words, the stationary vehicle monitoring module 122 can perform a process analogous to the process mentioned above for tracking moving vehicles. The module 122 rather monitors the stationary vehicle using the feature representations in a consecutive series of frames. The feature representations generated for corresponding locations/regions of a stationary vehicle should generally match. The vehicle is determined as being stationary for consecutive frames having substantially matching features at relatively constant locations in space.

One aspect of the vehicle tracking module 122 is that it identifies vehicles that are stationary for any period of inactivity. In the present endeavor of determining short-term parking violations, other factors must be considered that cause a vehicle to stay stationary over the period. For example, traffic congestion, red lights, stop signs, obstructions, and other conditions can also cause a vehicle to become inactive. These periods of inactivity are generally shorter. Therefore, a process is needed that measures the duration of time that the vehicle is stationary to distinguish whether a violation is in-fact occurring.

One aspect of the tracking and monitoring modules 120, 122 disclosed herein is that both update locations of detected objects after every video frame, which can include several updates per second. The timing module 124 uses this information to determine the amount of time that the vehicle remains parked in the parking space. Generally, the module 124 determines spatio-temporal information describing the location of the vehicle as a function of time. The module 124 determines the spatio-temporal information by associating the spatial location of the vehicle at each frame with a time instant at which the frame was captured at S534 at S522.

More specifically, the module 124 generates data that relates, for the sequence of frames, the pixel coordinates (output at S520) of the vehicle as a function of time. The location of the vehicle can be plotted as it traverses a scene. Using the data, the module 124 determines a start time when the vehicle initially becomes stationary. In the data plot, this frame is indicated at a point where the plot levels off. The duration that the vehicle remains parked is measured by the time that the plot remains approximately level. In other words, this duration can be computed as the difference between the times where the plot starts and stops being level at S524.

In one embodiment, the spatio-location information that is used by the vehicle tracking module 122 can undergo a filtering process before the module measures the time. The filtering can be used to reduce noise, cancel out inexistent motion, and prevent erroneous results. The results can further undergo a verification process to determine its accuracy.

In summary, the timing module 124 chronometers the time that elapses from the moment moving objects become stationary until the moment the objects become active again. One aspect of the timing module 124 is that it operates in conjunction with the vehicle tracking module 120 to start measuring duration when a vehicle pulls into a space. The timing module 124 triggers when the tracking module 120 indicates that a vehicle becomes stationary in an area of interest.

The elapsed times are provided to the notification module 126. In one embodiment, the timing module 124 can provide the notification module 126 with the elapsed time after a processing cycle of a predetermined duration. In one embodiment, the predetermined time can be in the order of a few seconds. In another embodiment, predetermined time interval can correspond to a multiple integer of the inverse of the video frame rate.

With continued reference to FIG. 5, the notification module 126 determines whether a short-term parking violation occurs. The module 126 receives the elapsed time (i.e., stationary duration) information from the timing module 124 for vehicles that are parked in a designated area of interest. The duration is compared to a threshold at S526. The threshold can be the maximum allowable parking time for the parking area and/or space of interest. This threshold can be obtained by an LUT stored in the storage device 106. The LUT can associate allowable time limits for parking in the particular spaces under surveillance.

The system provides no action when the duration does not meet the threshold (NO at S526). When the duration meets or exceeds the threshold (YES at S526), the system triggers a warning for a short-term parking violation at S528. A notification can be provided to a user device 104 indicating that the vehicle is violating a parking regulation. Once the violation is detected, the information can be sent to entities authorized to take action, such as law enforcement, for checking the scene, issuing a ticket, and/or towing the vehicle. In one embodiment, the information can be transmitted to the user-device of an enforcement officer for a municipality that subscribes to the service and/or is determined via GPS data to be within a region proximate the exclusion zone. In another embodiment, the information can be transmitted in response to a user-device 104 querying the system for the information. The information can indicate the location of the parking space, the vehicle description, including the vehicle type, brand, model, and color, etc. and the license plate number of the vehicle that is violating the regulation.

The system determines whether the current frame is the last frame in the sequence at S430. The process repeats starting at S504 in response to the current frame not being the last frame (NO at S530). In response to the current frame being the last frame (YES at S530, the method ends at 532.

### Alternate Embodiment

One aspect of the disclosure is that it tracks and monitors vehicles in motion. Example scenarios are contemplated to include a vehicle already parked in an observed space when the video sequence starts. Another embodiment of the system can include an initialization module 117 that is adapted to determine vehicles that are already stationary when the video feed starts. In other words, a vehicle is already parked in the camera field of view when the camera is calibrated, installed, and/or initialized. The initialization module 117 determines positions of the parked vehicles in a first frame of the sequence to detect vehicles that are already present in the short-term parking area. The initialization module 117 can perform further processing on the pixels in the initial frame to determine if the pixels belong to one of a vehicle and a non-vehicle. In one embodiment, the processing can include occlusion detection. In another embodiment, the processing can include shadow suppression. There is no limitation made herein directed toward the type of processing that can be performed for classifying the foreground pixels. One example of processing can include occlusion detection, which is described in co-pending application Atty. Dkt. No. 20120243-US-NP-XERZ202288US01, the teachings of which are fully incorporated herein.

The initialization module 117 generates a binary image of the background. Namely, the module 117 assigns “0” values to the pixels classified as belonging to the foreground image, that is, pixels identified as corresponding to vehicles in the first frame of the video, and “1” values to pixels classified as belonging to the background construct. The binary information can be used to trigger the timing module 124.

Although the method 500 is illustrated and described above in the form of a series of acts or events, it will be appreciated that the various methods or processes of the present disclosure are not limited by the illustrated ordering of such acts or events. In this regard, except as specifically provided hereinafter, some acts or events may occur in different order and/or concurrently with other acts or events apart from those illustrated and described herein in accordance with the disclosure. It is further noted that not all illustrated steps may be required to implement a process or method in accordance with the present disclosure, and one or more such acts may be combined. The illustrated methods and other methods of the disclosure may be implemented in hardware, software, or combinations thereof, in order to provide the control functionality described herein, and may be employed in any system including but not limited to the above illustrated system 100, wherein the disclosure is not limited to the specific applications and embodiments illustrated and described herein.

### Example Implementation

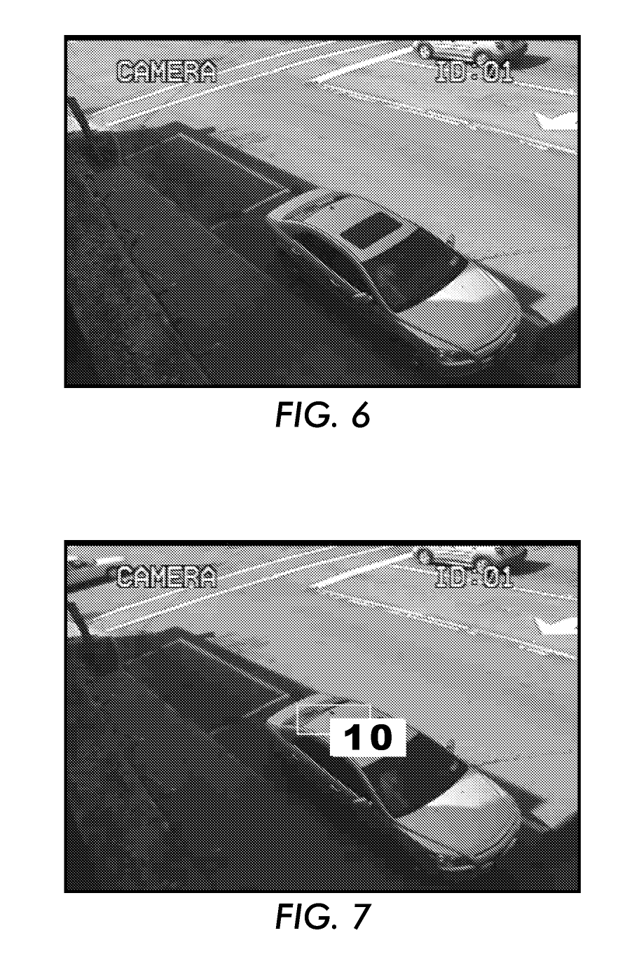

FIGS. 6-9 show an example implementation of the present disclosure. The proposed system and method was implemented and tested on video captured on a Webster Village (New York) street. FIG. 6 shows a sample video frame that illustrates a setup of the camera system and the configuration of the parking area that was monitored.

Since a vehicle depicted in FIG. 6 remained parked for the duration of the experiment, manual initialization of the algorithm was performed in lieu of the automated approach described for the vehicle detection module 118. The algorithm was manually notified of the presence of the vehicle in the observed parking space. In consequence, the algorithm started timing the vehicle occupancy from the first acquired frame.

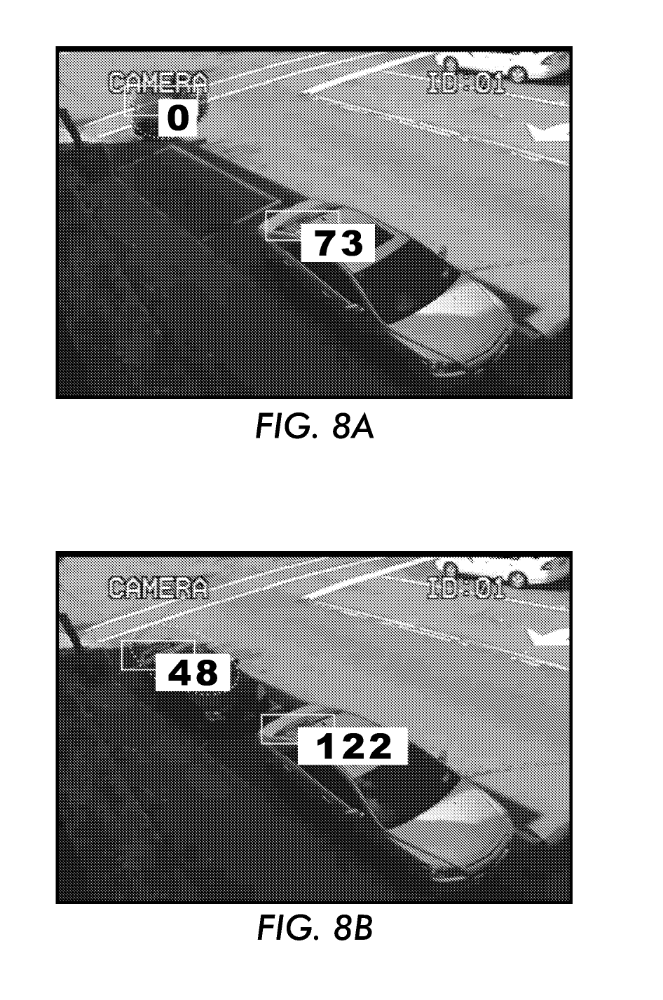

FIGS. 7, 8A, and 8B show a sample output frame. A pixel window is highlighted in a region associated with the vehicle that is being monitored. The image of FIG. 7 also displays the measured parking time for the vehicle of interest. In the example implementation, the measured parking time (10 seconds) is identical to the video running time, thus indicating that the vehicle was present in the video since the instant that the initial frame was captured.

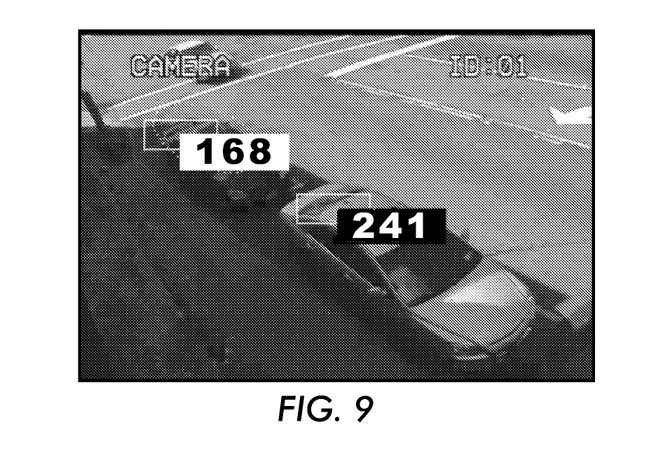

In order to illustrate the performance of the violation notification module 126, a fictitious time limit of 4 minutes was imposed. The moment that a parked car violated the parking time limit, a warning was triggered. The warning was visually indicated for illustration purposes. The visual notification consisted of a blinking timer that alternated between dark (bright) and bright (dark) timer readout backgrounds (numbers) (FIG. 9). In an actual implementation, this notification could be transmitted or communicated to the appropriate enforcement authority.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

1. A method for determining the occurrence of a short-term parking violation, the method comprising:
receiving video data in a sequence of frames provided by an associated image capture device monitoring a parking area over a duration of time;
determining the presence of a vehicle captured in at least one of the sequence of frames;
tracking the location of the vehicle across the sequence of frames, wherein the tracking includes:
determining a spatial location of the vehicle in a plurality of frames, and
determining spatio-temporal information describing the location of the vehicle as a function of time by associating the spatial location of the vehicle across the plurality of frames with the time instant at which the each frame of the plurality of frames was captured; and,
in response to the spatio-temporal information indicating that the vehicle becomes stationary, determining a duration that the vehicle is stationary using the determined spatio-temporal information of the vehicle.

2. The method of claim 1, wherein the determining the presence of the vehicle is performed by one of background subtraction, temporal difference, optical flow and an initialization process.

3. The method of claim 1, wherein the tracking the vehicle across the sequence of frames is achieved by one of point tracking, primitive geometric shape tracking, contour tracking, tracking based on the probability density function of the appearance of the object and tracking based on template matching.

4. The method of claim 1, wherein the providing the spatial location of the vehicle includes:
monitoring the location of the vehicle using the output of a tracking algorithm.

5. The method of claim 4, wherein the monitoring is performed at a predetermined time interval corresponding to a multiple integer of the inverse of the video frame rate.

6. The method of claim 1 further comprising:
comparing the duration to a threshold; and,
in response to the threshold being exceeded, triggering a warning for a short-term parking violation.

7. The method of claim 6, wherein the triggering includes:
providing a notification indicating that the vehicle is violating a parking regulation; and
providing vehicle information with the notification, wherein the vehicle information includes at least one of vehicle type, brand, model, color, and license plate number.

8. A computer program product comprising tangible media which encodes instructions for performing the method of claim 1.

9. A system for determining a parking violation comprising:
a monitoring device comprising memory which stores instructions for performing the method of claim 1 and a processor, in communication with the memory for executing the instructions.

10. A system for determining the occurrence of a short-term parking violation, the system comprising a monitoring device comprising:
a video buffering module adapted to receive video data in a sequence of frames provided by an image capture device in communication with the video capture device and monitoring a parking area over a duration of time;
a vehicle detection module adapted to determine a presence of a vehicle captured in at least one of the sequence of frames;
a vehicle tracking module adapted to track a spatial location of the vehicle across the sequence of frames;
a stationary vehicle monitoring module adapted to determine whether the vehicle has become stationary using the spatial location across the sequence of frames;
a timing module adapted to determine a duration that the vehicle is stationary using spatio-temporal information; and,
a processor adapted to implement the modules.

11. The system of claim 10, wherein the vehicle detection module is adapted to perform one of background subtraction, temporal difference and optical flow.

12. The system of claim 10, wherein the vehicle tracking module is adapted to perform one of point tracking, primitive geometric shape tracking, contour tracking, tracking based on the probability density function of the appearance of the object and tracking based on template matching.

13. The system of claim 10, wherein the stationary vehicle monitoring module is adapted to:
monitor a location of the vehicle using the output of a tracking algorithm.

14. The system of claim 10, wherein the stationary vehicle monitoring module monitors at a predetermined time interval corresponding to a multiple integer of the inverse of the video frame rate.

15. The system of claim 10 further comprising a notification module, the notification module adapted to:
compare the duration to a threshold; and,
in response to the threshold being exceeded, trigger a warning for a parking violation.

16. The system of claim 15, wherein the notification module is further adapted to:
provide a notification to a device in communication with the video buffering module indicating that the vehicle is violating a parking regulation; and,
provide vehicle information with the notification, wherein the vehicle information includes at least one of vehicle type, brand, model, color, and license plate number.
